(19) United States
(12) Patent Application Publication
(10) Pub. No.: US 2006/0149415 A1
(43) Pub. Date: Jul. 6, 2006

(54) Systems and methods for collecting vend data from, and exchanging information with, vending machines and other devices

(75) Inventor: Bobby D. Richards, Parker, CO (US)

Correspondence Address: PERKINS COIE LLP;PATENT-SEA, P.O. BOX 1247, SEATTLE, WA, 98111-1247, US

(73) Assignee: Coinstar, Inc., Bellevue, WA (US)

(21) Appl. No.: 11/009,371

(22) Filed: Dec. 10, 2004

(51) Int. Cl. G06F 17/00

(52) U.S. Cl. 700/236

(57) ABSTRACT

Systems and methods for exchanging information with vending machines and other devices are described herein. A vending machine configured in accordance with one embodiment of the invention includes a monetary input device and a data transceiver. The monetary input device can be configured to receive monetary instruments (e.g., coins, bills, or cards) from users of the vending machine. The data transceiver is configured to wirelessly transmit information received from the monetary input device to a data collection device spaced apart from the transceiver. In one embodiment, the vending machine can further include a metering component operably connected to the monetary input device and the transceiver. The metering component can be configured to compile vend data based on information received from the monetary input device. In this embodiment, the data transceiver can be configured to wirelessly transmit the vend data to the data collection device.

### TECHNICAL FIELD

The following disclosure relates generally to vending machines and other consumer-operated machines and, more particularly, to systems and methods for exchanging information with vending machines.

### BACKGROUND

There are many different types of vending machines. Bulk vending machines, for example, typically dispense a single type of product, such as a single type of candy, capsule toy, etc. Other vending machines can dispense a variety of products, such as a variety of different food products, soft drinks, etc. Still other vending machines, such as coin-operated washers, dryers, and telephones, offer services. In addition to food, prizes, and services, there are also vending machines that provide entertainment. Such machines include, for example, video games, kiddie rides, and skill games such as skill cranes. Skill cranes typically include a grasping device that the player maneuvers to try and grab a prize from within the machine.

Some vending machine companies own and operate thousands of machines spread out over many states. To service these machines, the companies typically employ route merchandisers (“merchandisers”) who are responsible for taking care of all the machines in a particular area or along a particular route. The merchandisers visit the machines periodically, collect the money inside, restock vended products or prizes, and perform any maintenance that may be needed. In addition, the merchandisers often test each machine to make sure it is fully operational. Such tests typically include, for example, running a preset amount of money through the machine to verify that the coin and/or bill acceptors are functioning properly.

Many vending machines include vend meters that track and display the number of sales or “vends” performed by the machines. When servicing such a machine, the merchandiser typically collects the money inside and records the number of vends displayed on the meter. The merchandiser then provides the vend data to the vending machine company along with the collected money. The vending machine company can then compare the vend data to the amount of money collected to verify there are no missing funds. Absent a vend meter, the merchandiser may be tempted to pocket a portion of the funds from the vending machine.

Vend meters can serve other functions in addition to loss prevention. For example, in the case of skill games that award prizes to winning players, the vend meters can be used to calculate vend ratios. The vend ratio is defined as the number of times a game was played divided by the number of times a prize was won. For a particular skill game, the vend company may only want to award a prize for, e.g., every fifth play, resulting in a vend ratio of 5-to-1. If the machine includes a vend meter, the merchandiser can easily check the vend ratio by dividing the total number of plays as read from the vend meter by the total number of prizes dispensed by the machine.

There are a number of different types of vend meters in use today. One problem with those having mechanical display devices, however, is that the display device can often be manipulated and reset with a dental pick or similar device. Another shortcoming with this type of vend meter is that the merchandiser has to manually record the vend data, which leaves the door open for further falsification or even innocent errors from misread or transposed numbers.

The EZ-count meter, provided by Nova Resolution Industries, Inc., of P.O. Box 240-T Bronx, N.Y. 10461, is a battery-operated vend meter having a digital display for use with bulk vending machines. The digital display largely alleviates the concern of manually resetting the vend data. However, this device is still susceptible to errors that can result from manual data recordation. In addition, this device uses a battery in conjunction with volatile memory. As a result, vend data is lost if the battery dies.

The Microvend System provided by Folz Vending Company, Inc., of 3401 Lawson Blvd., Oceanside, N.Y. 11572, is an electronic vend meter that can be hard-wired to a single machine or a group of machines (e.g., a group of bulk vending machines on a common rack). The Microvend System records vend data from each of the machines in dedicated memory. When a merchandiser services the machines, he or she connects a handheld computing device (e.g., a personal digital assistant) to the Microvend unit via a cable and downloads the vend data for each machine. While the Microvend System avoids the pitfalls of manual data entry, it still relies on battery power for data storage. As a result, a battery failure can result in a complete loss of vend data.

A further shortcoming associated with all the metering devices described above is that they lack a way to prevent losses associated with test plays. For example, as mentioned above, when a merchandiser removes funds from a particular vending machine, he or she will typically do a test to confirm that the vending machine is functioning properly. In a typical test, the merchandiser will take money collected by the machine and run it back through the machine to test operation. For example, if the machine is a skill crane with a dollar bill acceptor and one or more coin acceptors, the merchandiser will take one dollar bill and two quarters from within the machine and run them back through the machine to verify that the machine accepts the money and provides one play in return. Because the vend meter counts this test money twice, the actual amount of money collected from the machine will necessarily be $1.50 less than the total counted by the vend meter. If the merchandiser actually performs a test play, this difference does not represent a real loss to the vending machine company. However, if the merchandiser decides to simply pocket the test money and not perform the test, then the company loses on two counts. First, the machine will not have been tested. Consequently, if it is malfunctioning, it will remain out of order resulting in a loss of revenue, good will, etc. Second, the vending machine company will have sustained an actual loss of the test play money. For companies with thousands of machines, the financial losses from fraudulent test plays can be substantial.

### BRIEF DESCRIPTION OF THE DRAWINGS

FIG. 1 is an isometric view of a vending machine having a data transceiver configured in accordance with an embodiment of the invention.

FIG. 2 is an enlarged isometric view of the vending machine of FIG. 1 showing a door of the vending machine in an open position.

FIGS. 3A-C are various views of a data collection device that can be used to exchange information with the data transceiver shown in FIGS. 1 and 2.

FIG. 4 illustrates a route merchandiser servicing the vending machine of FIGS. 1 and 2 in accordance with an embodiment of the invention.

FIG. 5 is a flow diagram illustrating a process for servicing a vending machine in accordance with an embodiment of the invention.

FIG. 6 is a flow diagram illustrating a routine for operating a data collection device in accordance with an embodiment of the invention.

FIG. 7 is a flow diagram illustrating a routine for operating a data collection device in accordance with another embodiment of the invention.

FIG. 8 is a flow diagram illustrating a routine for operating a data collection device in accordance with a further embodiment of the invention.

FIG. 9 is a flow diagram illustrating a routine for operating a data transceiver in accordance with an embodiment of the invention.

FIG. 10 is a schematic diagram of a data transceiver and a data collection device configured in accordance with an embodiment of the invention.

### DETAILED DESCRIPTION

The following disclosure describes various systems and methods for collecting vend data from, and exchanging information with, vending machines and other devices. Specific details of several embodiments of the invention are described below to provide a thorough understanding of these embodiments. Other details describing well-known aspects of vending machines and related data collection devices are not set forth below, however, to avoid unnecessarily obscuring the description of the various embodiments. Furthermore, those of ordinary skill in the art will understand that the invention can have other embodiments in addition to those described below. Such embodiments may lack one or more of the elements described below or, conversely, they may include other elements in addition to those described below.

Certain embodiments are described below in the context of computer-executable instructions performed by a general-purpose computer, personal digital assistant, or other processing device. The computer-executable instructions can be stored on various types of computer-readable media including, for example, hard disks, floppy disks, or CD-ROMs. In other embodiments, these instructions can be stored on a server computer system and accessed via a computer network such as an intranet or the Internet. Because the basic structures and functions often associated with computer systems and related routines are well known, they have not been shown or described in detail here to avoid unnecessarily obscuring the described embodiments.

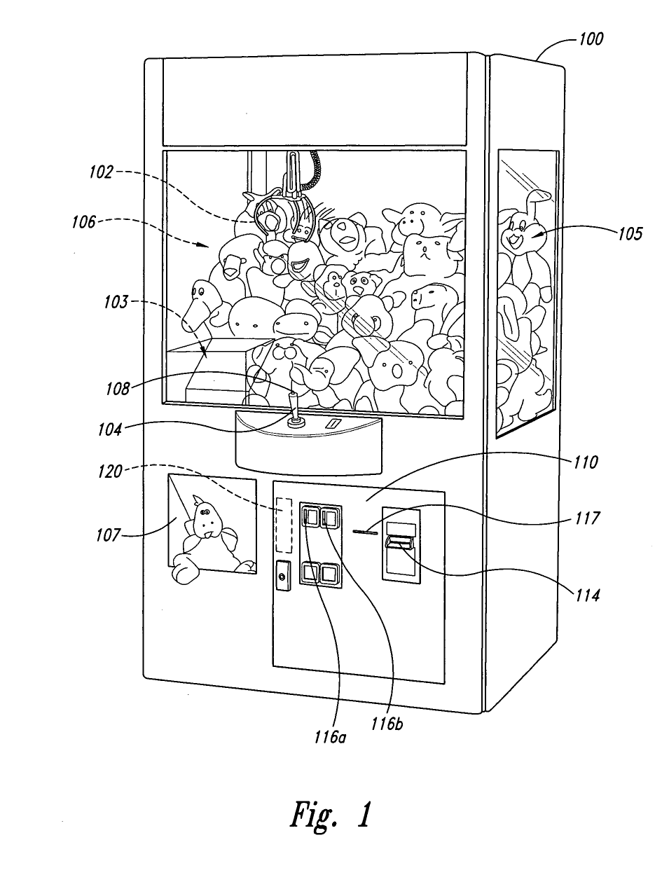

In the Figures, identical reference numbers identify identical or at least generally similar elements. To facilitate the discussion of any particular element, the most significant digit or digits of any reference number refer to the Figure in which that element is first introduced. For example, element 110 is first introduced and discussed with reference to FIG. 1.

FIG. 1 is an isometric view of a vending machine 100 having a data transceiver 120 configured in accordance with an embodiment of the invention. As described in greater detail below, the data transceiver 120 is configured to wirelessly transmit vend data from, and receiving various types of information for, the vending machine 100. In the illustrated embodiment, the vending machine 100 is a skill game. Accordingly, in the description that follows, the data transceiver 120 and related systems are described in the context of a skill game. In other embodiments, however, the data transceiver 120 described herein can be used with many other types of machines including, for example, vending machines, rides, games, washers/dryers and other service machines, slot machines and other gambling machines, consumer-operated coin-counting machines, phone card machines, pre-paid credit/debit card machines, stamp machines, pay telephones, parking meters, other money-receiving machines, etc. Accordingly, the term “vending machine” as used throughout this disclosure can refer to any machine that receives money and/or monetary value (e.g., monetary value from a credit card, debit card, stored-value card, etc.) from a user in return for a product, service, chance, and/or experience.

In one aspect of this embodiment, the data transceiver 120 is mounted to a door 110 of the vending machine 100 adjacent to a plurality of monetary input devices. The monetary input devices can include, for example, a bill acceptor 114, coin slots 116a and 116b, and a card reader 117. The bill acceptor 114 is configured to receive bills, e.g., one-dollar bills. The coin slots 116 are configured to receive one or more denominations of coin, e.g., quarters. The card reader 117 can be configured to read credit, debit, stored-value, and/or other types of card instruments capable of transferring monetary value.

As mentioned above, in the illustrated embodiment the vending machine 100 is a skill game. In particular, the vending machine 100 is a skill crane that further includes a user-operable controller or joystick 104 operably connected to a grasping device or claw 102. The claw 102 is movably positioned within a merchandize-holding portion 105 of the vending machine 100 above a plurality of prizes 106 (e.g., plush toys). The claw 102 is configured to respond to movement of the joystick 104. For example, movement of the joystick 104 to the left causes the claw 102 to move to the left. Similarly, movement of the joystick to the right causes the claw 102 to move to the right. Pressing a button 108 on the joystick 104 causes the claw 102 to descend and simultaneously close on one or more of the prizes 106 in its path.

To operate the vending machine 100, a user (not shown) begins by inputting the required monetary amount via one or more of the monetary input devices. For example, if the game costs $.50 for each play, the user can input a one dollar bill in the bill acceptor 114 or one or more quarters in the coin slots 116. Alternatively, the user may elect to swipe his or her credit, debit, or other type of payment card through the card reader 117 to authorize payment via this device. After inputting payment, the user operates the joystick 104 and tries to position the claw 102 over a desired prize 106. Once the claw 102 is in position, the user depresses the button 108 causing the claw 102 to drop and close. If the user is lucky, the claw 102 will grasp the desired prize 106. After closing, the claw 102 automatically retracts upwardly, moves to a position above an outlet chute 103, and opens. If the claw 102 was holding a prize, the prize drops into the outlet chute 103 and is delivered to the winning user via an outlet 107.

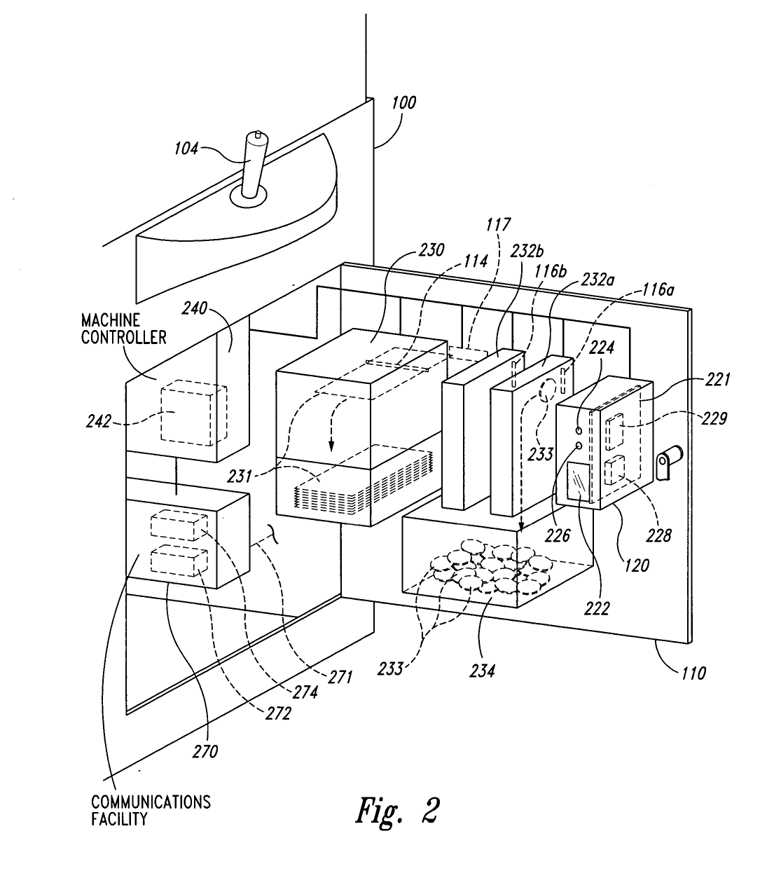

FIG. 2 is an enlarged isometric view of the vending machine 100 with the door 110 in an open position. A bill counter 230 and coin counters 232a and 232b are mounted to the backside of the door 110. The coin counters 232 are configured to receive coins 233 via the corresponding coin slots 116. Valid coins are counted by the coin counters 232 and deposited in a coin bin 234 positioned beneath the coin counters 232. Invalid coins are rejected and returned to the user. The bill counter 230 is configured to receive bills 231 via the bill slot 114. Valid bills are counted and held by the bill counter 230, while invalid bills are rejected and returned to user.

The bill counter 230, the coin counters 232, and the card reader 117 are operably connected to a vending machine controller 240 positioned within the vending machine 100. The vending machine controller 240 can receive power via a cord plugged into a standard facility outlet (not shown). In addition, the vending machine 100 can also include one or more batteries to provide back-up power in the event that facility power becomes temporarily unavailable. The vending machine controller 240 controls the operating functions of the vending machine 100. For example, when the monetary input devices receive enough money for one play, the controller 240 responds by activating the joy stick 104 and the claw 102 (FIG. 1) for one play. In addition to controlling the operating functions of the vending machine 100, the controller 240 also includes an electronic metering component 242 (shown schematically in FIG. 2). The metering component 242 can include one or more processors, routers, and/or memory devices (e.g., non-volatile memory devices) suitable for counting and/or recording various types of “vend data.” This vend data can include, for example, the total number of times—starting from some particular point in time—that the vending machine 100 has been played and the corresponding monetary value received via the coin counters 232, the card reader 117, and/or the bill counter 230 for those plays; the number of times the vending machine 100 has been played since the machine was last serviced and the corresponding monetary value received for those plays; the total number of test plays starting from a particular point in time; the number of test plays since the machine was last serviced; and other data including, but not limited to, the dates when the machine was serviced, the ID numbers of the merchandisers who performed the services, the number of prizes won, the types of prizes won, the dates and times associated with the vends, etc.

In one aspect of this embodiment, the vending machine controller 240 is operably connected to the data transceiver 120 and configured to provide various types of information to the data transceiver 120. Such information can include, for example, the various types of vend data described above. In addition to receiving information from the controller 240, the data transceiver 120 is also configured to provide various types of information to the controller 240. As described in greater detail below, such information can include, for example, various operating parameters for the vending machine 100.

In another aspect of this embodiment, the data transceiver 120 includes a body 221 attached to the vending machine door 110 adjacent to the coin counters 232. The body 221 includes a signal port 222, e.g., an infrared port, a first visual indicator 224, and a second visual indicator 226. In the illustrated embodiment, the first and second visual indicators 224 and 226 include colored lights (e.g., laser-emitting diodes (LEDs) with green and red colored lenses, respectively) configured to provide a visual indication of the operating mode of the data transceiver 120. The signal port 222 is configured to let signals, e.g., infrared signals, pass to and from a transceiver module 228 (e.g., an optical transceiver module, shown schematically in FIG. 2) positioned within the body 221.

As described in greater detail below, the transceiver module 228 positioned within the data transceiver 120 is configured to wirelessly transmit information to a hand-held device (not shown in FIG. 2) positioned separately from the data transceiver 120. Such information can include, for example, vend data received from the metering component 242 in the machine controller 240. In addition, the optical transceiver module 228 is further configured to receive information from the hand-held device and transmit the information to the machine controller 240. Such information can include, for example, various operating instructions and parameters for the vending machine 100 including, but not limited to, claw operating voltage to control the vend ratio. As used herein, the term “wireless” is used to describe a form of communication in which the signal is carried over part or all of the communication path without some form of wire.

In a further aspect of this embodiment, the data transceiver 120 includes a security component 229 (shown schematically). The security component 229 is configured to prevent an unauthorized person from tampering with the vending machine 100, the data transceiver 120, or trying to circumvent one or more of the counting functions performed by the metering component 242 of the machine controller 240. In this regard, if the data transceiver 120 is disconnected from the machine controller 240 or powered off, the vending machine 100 will go into a “trouble” mode and/or be rendered inoperable. Once the data transceiver 120 is reconnected or powered up, the machine will become fully functional.

In yet another embodiment of the invention, the vending machine 100 can further include a communications facility 270 operably connected to the machine controller 240. The communications facility 270 can be used in place of, or in conjunction with, the data transceiver 120 to automatically communicate vend data and other information from the vending machine 100 to a remote computer, e.g., a central computer controlled by the vending machine company that owns and operates the vending machine 100. In addition, the communications facility 270 can also be configured to automatically receive information, e.g., vending machine operating instructions, from the remote computer. In one embodiment, the communications facility 270 can include a modem 272 to perform these functions. The modem 272 can be configured to automatically transmit vend data and other information received from the vending machine controller 240 to a remote computer or other device via a phone line 271. In addition, the modem 272 can also receive information from the remote computer or other device via the phone line 271. In another embodiment, the communications facility 270 can include a transceiver 274, e.g., a two-way paging device, that can wirelessly transmit vend data and other information to, and receive information from, a remote station or device. The transceiver 274 may be advantageous in those applications where a phone line is not available.

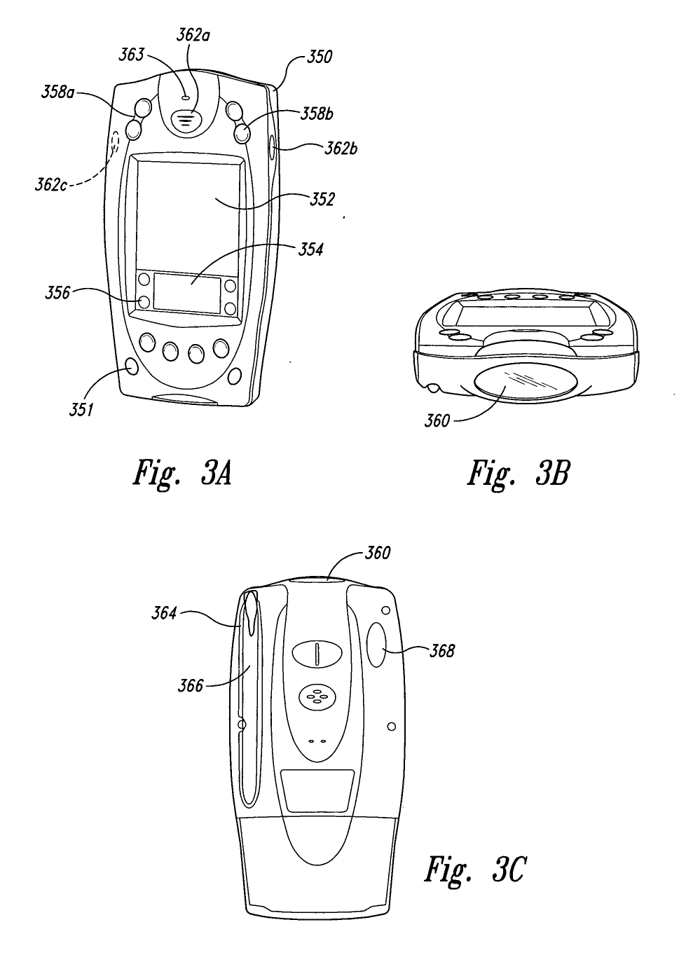

FIGS. 3A-C are various views of a suitable data collection device 350 that can be used to exchange information with the data transceiver 120 of FIG. 2. In one embodiment, the data collection device 350 can be at least generally similar in structure and function to the SPT1800 hand-held computer provided by Symbol Technologies, Inc. of One Symbol Plaza, Holtzville, N.Y., 11742. Information about the SPT1800 hand-held computational device can be found in the SPT1800 Product Reference Guide, Part Number: 72-51337-06, Rev. A, dated March 2003, which is incorporated herein in its entirety by reference. In other embodiments, other wireless communication devices, including other personal digital assistants (PDAs), can be used to receive information from, and/or transmit information to, with the data transceiver 120.

Referring to FIGS. 3A-C together, in one aspect of this embodiment, the data collection device 350 includes a scanner window 360 for scanning symbology, such as an RFID tag and/or a bar code. To scan a bar code, the user selects, e.g., by tapping, a menu icon 356a (with, e.g., a stylus 366) to bring up an application menu on a display screen 352. The user selects the desired scanning application from the menu and then aims the scanner 360 at the bar code of interest. Next, the user presses a center scan button 362a, a right scan button 362b, or a left scan button 362c and directs a red scan beam emanating from the scanner 360 at the bar code. A visual indicator 363 flashes and a beep sounds to indicate the bar code was successfully decoded.

The data collection device 350 also includes features for wirelessly receiving and transmitting information via infrared signals. In one embodiment, to wirelessly transmit information, the user turns on the data collection device 350 via a power button 351 and locates an application or other information in memory that he or she wishes to transmit to a receiving device (e.g., the data transceiver 120 of FIG. 2). Next, the user selects the menu icon 356a to bring up the application menu on the display screen 352. The user then selects a beam command from the menu to open a beam status screen (not shown). Next, the user orients an infrared port 368 (FIG. 3C) so that it faces a corresponding infrared port on the receiving device (not shown). The data collection device 350 then transmits the desired information to the receiving device according to a preset protocol. The beam status screen indicates when the transfer is complete.

To wirelessly receive information in one embodiment, the user turns on the data collection device 350 via the power button 351, and positions the infrared port 368 in front of the infrared port of the transmitting device to open the beam status screen on the display screen 352. Once the data has been received by the data collection device 350, the user taps a “yes” button on the display screen 352 to accept the transmission. The user then waits for the beam status screen to indicate the transfer is complete, and then taps a corresponding “OK” button to display the downloaded data. The user can then store and/or use the data as desired. However, as described in greater detail below, in one embodiment if the data includes vend data, the user will not be able to manipulate and/or alter the data.

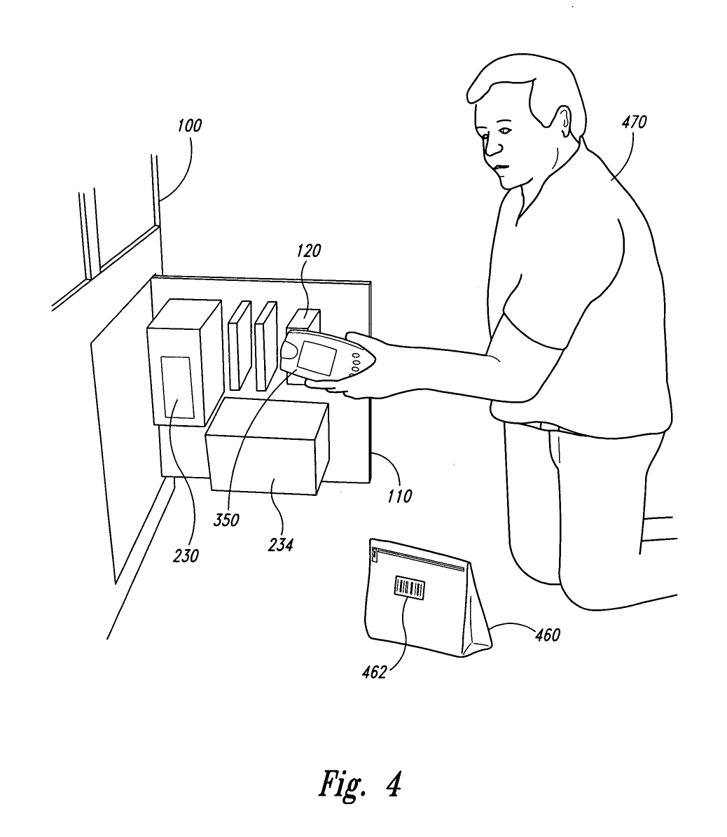

FIG. 4 illustrates a route merchandiser 470 servicing the vending machine 100 in accordance with an embodiment of the invention. Initially, the route merchandiser 470 opens the door 110, retrieves coinage from the coin bin 234 and bills from the bill counter 230, and places them in a cash collection bag 260. Next, the merchandiser 470 uses the data collection device 350 as described above with reference to FIGS. 3A-C to scan a bar code 462 or other identifier on the collection bag 460. This step digitally associates the money in the collection bag 460 with the particular servicing event. The merchandiser 470 then positions the data collection device 350 in front of the data transceiver 120 so that the infrared port 368 on the device is facing the signal port 222 on the data transceiver 120. Next, the merchandiser 470 uses the data collection device 350 as described above with reference to FIGS. 3A-C to down-load data from the data transceiver 120. Such data can include, for example, a machine identifier, time and date of service, and various types of vend data associated with the money collected from the machine. As described in greater detail below, the merchandiser 470 can also use the data collection device 350 at this time to perform and document a test play of the vending machine 100.

One feature of the embodiments described above with reference to FIGS. 1-4 is that the data collection device 350 is not hard-wired to the data transceiver 120 during the data download process. This feature cuts down on the wear and tear of connectors, cables, and other hardware components that can result from years of use. Another feature of these embodiments is that the metering component 242 (FIG. 2) can include non-volatile memory. Thus, even if the vending machine loses power, the vend data will not be lost.

In various embodiments of the invention described above, information is wirelessly communicated between the data transceiver 120 and the data collection device 350 with infrared signals. In other embodiments, however, other types of wired and wireless communication links can be used to exchange vend data and other information with the vending machine 100 and systems thereof. Wireless communication links can include, for example, radio frequency, electromagnetic, and microwave technology. Such communication links can include various protocols such as Wi-Fi, Bluetooth, Ibutton, 3G, WiMax, etc. Wired communication links can employ various hardware devices including, for example, fiber-optic cables, modems, telephone lines, pocket pcs, lap-top computers, etc. Further, once information has been downloaded from the data transceiver 120 to the data collection device 350, the down-loaded data can be automatically and/or manually communicated from the data collection device 350 to a remote station (e.g., a central computer of the vending machine company) using one or more of the mediums described above.

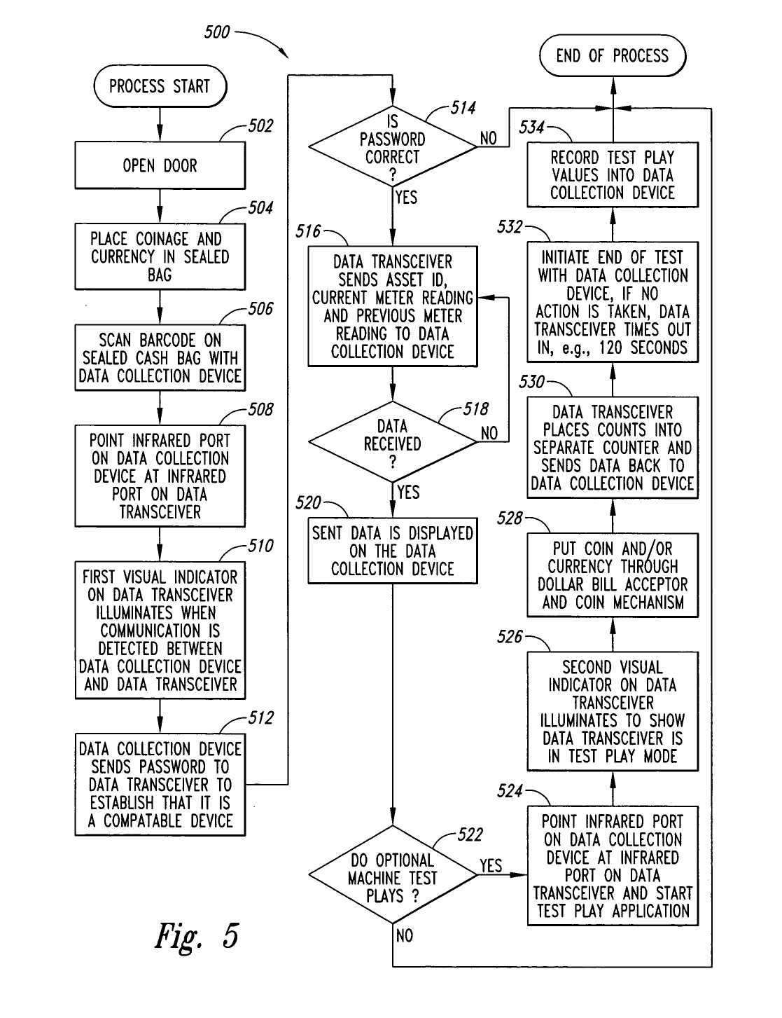

FIG. 5 is a flow diagram illustrating a process 500 for servicing a vending machine in accordance with an embodiment of the invention. In block 502, the process begins when a route merchandiser or other person opens a door of the vending machine to access the money within. In block 504, the merchandiser collects the money and places it in a cash bag. In block 506, the merchandiser scans a bar code on the sealed cash bag with a data collection device. In one aspect of this embodiment, the data collection device can be at least generally similar in structure and function to the data collection device 350 described above with reference to FIG. 3. Next, the merchandiser orients a first infrared port on the data collection device relative to a second infrared port on a data transceiver mounted to the door (or other part) of the vending machine, and initiates communication between the data collection device and the data transceiver.

In block 510, a first visual indicator (e.g., the first visual indicator 224 of FIG. 2) on the data transceiver illuminates indicating communication between the data collection device and the data transceiver has begun. In block 512, the data collection device sends a password to the data transceiver. In decision block 514, the data transceiver determines if the password is correct. If the password is not correct, the process ends. If the password is correct, the process continues to block 516.

In block 516, the data transceiver sends an asset ID number, a current meter reading, and a previous meter reading to the data collection device. In one aspect of this embodiment, the asset ID number corresponds to a serial number or other identification number of the vending machine being serviced. In another aspect of this embodiment, the current meter reading corresponds to the total number of sales or “vends” performed by the machine since an initial “start time.” The start time could be, for example, the time when the data transceiver was initially installed or some other selected datum. The previous meter reading corresponds to the total number of vends performed by the machine from the start time to the point in time at which the machine was last serviced. Accordingly, the difference between the current meter reading and the previous meter reading is equal to the number of vends performed by the machine in the time period since it was last serviced.

In decision block 518, the data transceiver exchanges signals with the data collection device to confirm that the data collection device received the transmitted data (i.e., the asset ID number, current meter reading, and previous meter reading). If not, then the process returns to block 516 and repeats. If the data collection device did receive the data, then the process proceeds to block 520 and the data is displayed on the data collection device. At this time, the merchandiser can perform various calculations with the meter readings, but the merchandiser is not able to change the values. Such calculations can include, for example, determining a vend ratio for the vending machine if the vending machine is a skill game similar to that described above with reference to FIG. 1.

In decision block 522, the merchandiser has the option of conducting a test play of the vending machine. If the merchandiser elects not to test the machine, then the process is complete. If, however, a test play is called for, then in block 524 the merchandiser directs the first infrared port of the data collection device at the second infrared port on the data transceiver and initiates a test play application on the data collection device. In block 526, a second visual indicator (e.g., the second visual indicator 226 of FIG. 2) on the data transceiver illuminates indicating that the data transceiver is now in test play mode. In block 528, the merchandiser inserts the appropriate amount of coin and/or currency through the corresponding coin acceptor and/or bill acceptor, respectively. For example, if one play (or, alternatively, one purchase, one phone call, etc.) costs $1.50, then the merchandiser can insert a one dollar bill and two quarters through the appropriate monetary input devices. Alternatively, if the vending machine is equipped with a card reader or similar device for receiving monetary value from a credit/debit card, stored-value card, or similar instrument, then the merchandiser can input funds through this device in block 528. Once the money is received, it is counted by the corresponding counting device or devices and the associated information is communicated to the data transceiver via a vending machine controller (e.g., the vending machine controller 240 of FIG. 2). In block 530, the data transceiver places this test play data into a counter that is separate from the main counter which stores, e.g., the current and previous meter readings. The data transceiver then sends the test play data to the data collection device.

In block 532, the merchandiser can initiate an end of test sequence with the data collection device. Alternatively, if no action is taken, then the data transceiver can automatically terminate communication with the data collection device after a preset period of time, e.g., 120 seconds. In block 534, the test play data is recorded into the data collection device along with the vend data previously collected, and then the process ends.

Subsequently, the data collected by the data collection device can be transferred by any number of means, including wireless and wired, and in any number of forms, to the vending machine company along with the collected funds. The information can be used by the vending machine company for various purposes. Including, for example, to verify the appropriate amount of funds were collected from the machine, to verify the machine was adequately tested and is functioning properly, and/or to check vend ratios.

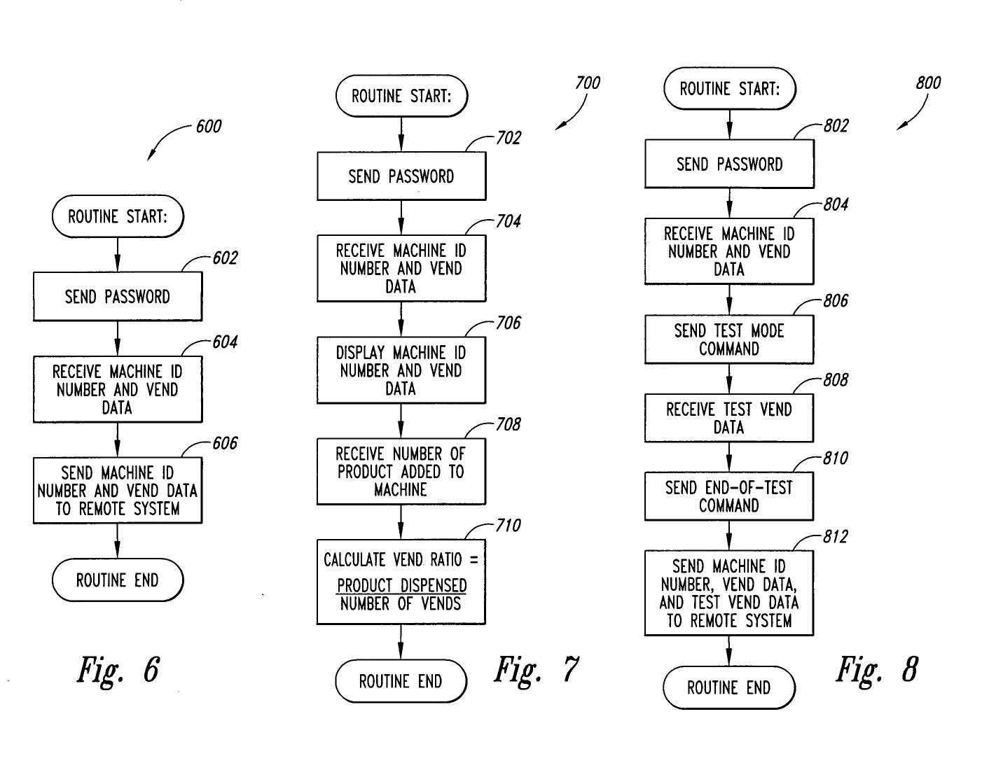

FIG. 6 is a flow diagram of a routine 600 for operating a data collection device (e.g., the data collection device 350 of FIGS. 3A-C and 4) in accordance with an embodiment of the invention. In one aspect of this embodiment, the routine 600 can be performed in accordance with computer-readata collection device 3501e instructions stored on a computer-readata collection device 3501e medium. The routine 600 can start when a route merchandiser or other user positions an infrared port on the data collection device in front of an infrared port on a remote device (e.g., the data transceiver 120 described above with reference to FIGS. 1, 2 and 4). In block 602, the routine 600 sends a password from the data collection device to the remote device. In block 604, in response to sending the password, the routine receives vend data and a machine identification number from the remote device. In one embodiment, the machine identification number corresponds to a particular vending machine, and the vend data includes one or more of the various types of vend data described above with reference to FIGS. 1 and 2.

In block 606, the routine 600 sends the machine identification number and the vend data to a remote computing system. In one embodiment, the remote computing system can be a central computing system of a vending machine company that owns the particular vending machine. In addition to sending the machine identification number and the vend data, in other embodiments, the routine 600 can also send other information including, for example, the date and time the vend data was downloaded from the particular vending machine.

FIG. 7 is a flow diagram illustrating a routine 700 for operating a data collection device in accordance with another embodiment of the invention. In block 702, the routine sends a password from the data collection device to a remote device (e.g., the data transceiver 120 described above with reference to FIGS. 1, 2 and 4). In block 704, the routine 700 receives vend data and a machine identification number from the remote device. In block 706, the routine displays the machine identification number and the vend data on, e.g., a display screen or other suitable display device. In one aspect of this embodiment, an operator or other user can then view and/or perform calculations with the displayed data. In other embodiments, this step can be omitted.

In block 708, the routine receives a number corresponding to the number of prizes dispensed from the machine since it was last serviced. In one aspect of this embodiment, this number can be manually entered by a route merchandiser or other user. In block 710, the routine 700 calculates a vend ratio by dividing the number of plays since the game was last serviced (extracted from the vend data) by the number of prizes won in that same period. After block 710, the routine ends.

FIG. 8 is a flow diagram of a routine 800 for operating a data collection device in accordance with a further embodiment of the invention. In block 802, the routine 800 sends a password from the data collection device to a remote device (e.g., the data transceiver 120 described above with reference to FIGS. 1, 2 and 4). In block 804, the routine receives vend data and a machine identification number from the remote device. In block 806, the routine 800 sends a test mode command to the remote device. In one aspect of this embodiment, the test mode command instructs the remote device that a subsequent vend or vends of the machine correspond to a test (e.g., a “test play”) and should be recorded as such. Accordingly, at this point in time a merchandiser or other user can run coins, bills, and/or cards through the corresponding monetary input devices on the machine to test their function. After the merchandiser performs the test, in block 808, the routine 800 receives corresponding test vend data from the remote device. After receiving the test vend data, the routine 800 sends an end-of-test command in block 810. In other embodiments, this step can be omitted and the vending machine can automatically return to operational mode after a preset period of time subsequent to receiving the test mode command. In block 812, the routine 800 sends the machine identification number, the vend data, and the test vend data to a remote computing system, and the routine ends.

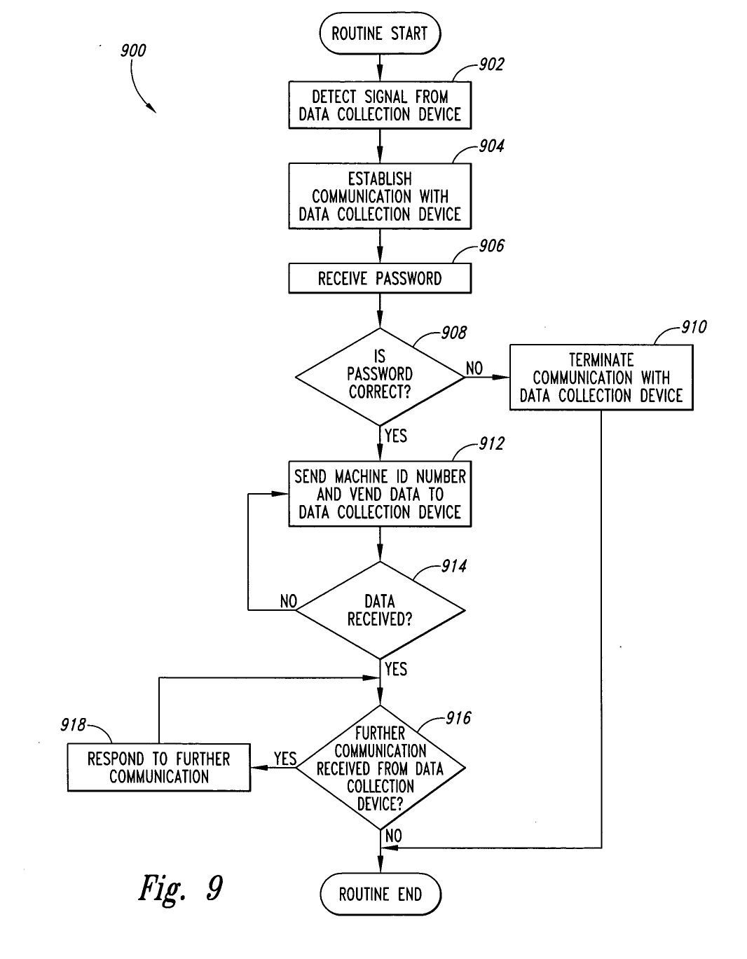

FIG. 9 is a flow diagram of a routine 900 for operating a data transceiver (e.g., the data transceiver 120 described above with reference to FIGS. 1, 2 and 4) in accordance with an embodiment of the invention. In block 902, the routine 900 detects a signal (e.g., a wireless signal) from a remote device (e.g., the data collection device 350 described above with reference to FIGS. 3A-C and 4). In block 904, the routine 900 establishes communication with the remote device. In block 906, the routine 900 receives a password from the remote device.

In decision block 908, the routine 900 determines if the password is valid. If not, then in block 910 the routine 900 terminates communication with the data collection device and the routine ends. If the password is correct, then in block 912 the routine 900 sends a machine identification number and vend data to the remote device. In one embodiment, the machine identification number identifies the vending machine upon which the data transceiver is mounted, and the vend data includes various types of vend data for that particular machine. In decision block 914, the routine 900 determines if the sent data (i.e., the machine identification number and the vend data) was received by the remote device. If not, the routine 900 returns to block 912 and repeats. If the sent data was received, then the routine 900 proceeds to decision block 916 to determine if further communications have been received from the remote device. If so, then the routine 900 proceeds to block 918 and responds to the further communication. After responding to the further communication, the routine returns to decision block 916 and repeats. If there are no further communications from the remote device in decision block 916, the routine ends.

In various embodiments of the invention described above, the data transceiver 120 (FIGS. 1, 2 and 4) and the data collection device 350 (FIGS. 3A-C and 4) communicate via infrared signals. In other embodiments, however, these devices can be configured to communicate using other forms of wireless communication. For example, in another embodiment, these devices can be configured to communicate using radio frequency or microwave signals. Accordingly, the term “wireless communication” as used herein is not limited to infrared frequency communication, but instead extends to other forms of telecommunications in which electromagnetic waves, rather than some form of wire, carry the signal over part or all of the communication path.

While radio frequency and infrared are both popular forms of wireless communication, infrared (IR) technologies may be better suited for short distance, low to medium data throughput, wireless communication. Two types of IR technology currently in use are the TV Remote (TVR) and the Infrared Data Association (IrDA) standard protocols. TVR, however, is mainly employed for unidirectional low bit-rate communication. In one embodiment of the present invention, the data transceiver 120 and the data collection device 350 both include infrared transceivers that support the IrDA standard protocol for communication.

The IrDA standard protocol, defined by the IrDA consortium, is a network protocol and follows a layered approach in its definition. The protocol specifies standards for both physical devices and protocols that the devices use to communicate with each other. The protocol is an ensemble of different protocols that manage different aspects of two-way infrared communication. The different protocols include the IrDA Infrared Link Access Protocal (IrLAP), the IrDA Infrared Link Management Protocal (IrLMP), the IrDA Transport Protocals (Tiny TP), and the IrDA Object Exchange Protocal (IrOBEX). Each of these protocols handles a set of responsibilities while providing needed capabilities to the layers above and below. In various embodiments, the devices described herein can communicate using infrared laser emitting diodes (LED's) to emit signals and positive-intrinsic-negative (PIN) photodiodes in generation mode to receive signals. For a number of reasons, it may be advantageous for the IrDA signal modulation method to be pulse modulation.

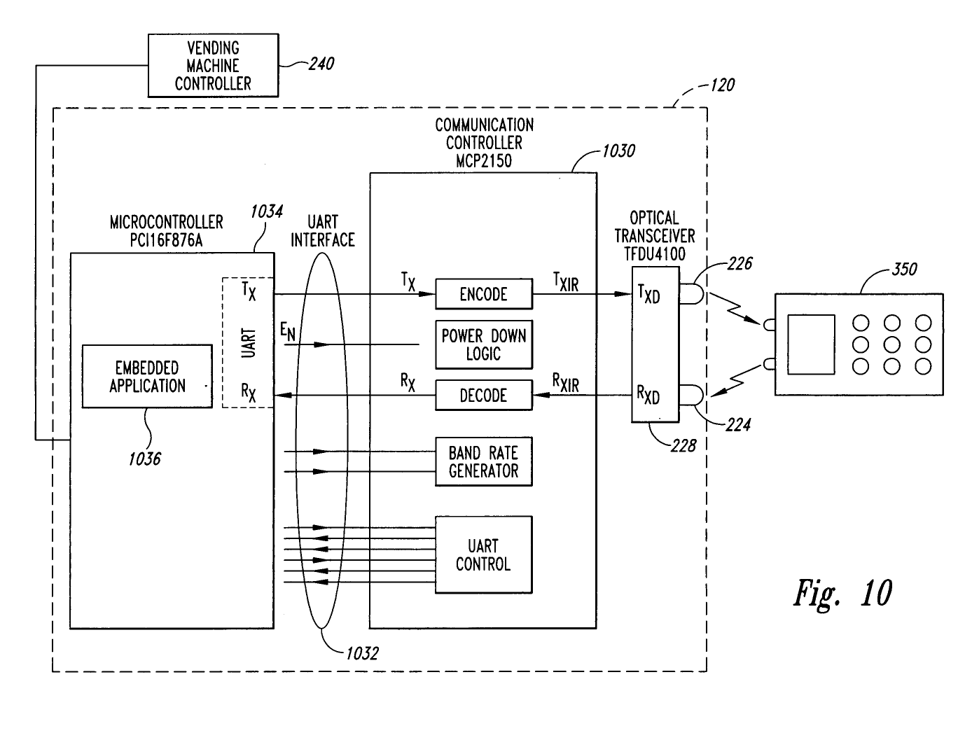

FIG. 10 is a schematic diagram of the data collection device 350 and the data transceiver 120 configured in accordance with an embodiment of the invention. In one aspect of this embodiment, the data transceiver 120 includes three functional modules: the optical transceiver module 228, a communication controller 1030, and a microcontroller 1034. In the illustrated embodiment, the optical transceiver module 228 is a TFDU4100 serial infrared transceiver made by Vishay Semiconductors, Inc. The TFDU4100 complies with the IrDA physical layer and background light specifications up to a data rate of 115.2 kbit/s. The optical transceiver module 228 can include an infrared transmitter 226 (e.g., an infrared emitter diode (IRED)), an infrared receiver 224 (e.g., a PIN photodiode), and a low-power analog control integrated circuit (not shown). The TFDU4100 uses a small Baby Face package with surface-mount solderability.

The communication controller 1030 is configured to translate communication between the optical transceiver module 228 and the microcontroller 1034. In the illustrated embodiment, the communication controller 1030 is an MCP2150 controller made by Microchip Technology, Inc. The MCP2150 implements the IrDA standard protocol stack by decoding and encoding the signals it receives from the optical transceiver module 228 and the microcontroller 1034. One of the functions of the MCP2150 is to encode and decode asynchronous serial data streams.

The microcontroller 1034 (or “controller 1034”) is configured to receive various types of vend data and/or other information (e.g., machine identification numbers, date and times, etc.) from the vending machine controller 240. The microcontroller 1034 of the illustrated embodiment is a PIC16F876A CMOS FLASH-based 8-bit controller manufactured by Microchip Technology, Inc. It features an imbedded application 1036, 256 bytes of EEPROM data memory, self programming, an In Circuit Debugger (ICD), two comparators, five channels of 10-bit Analog-to-Digital (A/D) converter, two capture/compare/PWM functions, and a Universal Asynchronous Receiver Transmitter (UART). The microcontroller 1034 sends data to and receives data from the communication controller 1030 via a UART interface port 1032.

The optical transceiver module 228 can wirelessly receive data from the data collection device 350 and transmit the data to the communication controller 1030. The communication controller 1030 can decode the transmitted data into UART standard, and send the data to the microcontroller 1034 through the UART interface port 1032. The microcontroller 1034 can also send data to the communication controller 1030. The communication controller 1030 can encode the data received from the microcontroller 1034 and prepare it for transmission to the data collection device 350 via the optical transceiver module 228.

From the foregoing, it will be appreciated that specific embodiments of the invention have been described herein for purposes of illustration, but that various modifications may be made without deviating from the spirit and scope of the invention. For example, aspects of the invention described in the context of particular embodiments may be combined or eliminated in other embodiments. Further, while advantages associated with certain embodiments of the invention have been described in the context of those embodiments, other embodiments may also exhibit such advantages, and no embodiment need necessarily exhibit such advantages to fall within the scope of the invention. Accordingly, the invention is not limited, except as by the appended claims.

I/We claim:

1. A communication device for use with a vending machine, the communication device comprising:
a body configured to be attached to a portion of the vending machine;
a controller supported by the body, wherein the controller is configured to receive information from the vending machine; and
a transmitter operably connected to the controller, wherein the transmitter is configured to wirelessly transmit at least a portion of the information received from the vending machine to a data collection device spaced apart from the communication device.

2. The communication device of claim 1 wherein the transmitter is configured to transmit at least a portion of the information received from the vending machine via infrared signals.

3. The communication device of claim 1 wherein the transmitter includes an infrared emitter diode configured to transmit at least a portion of the information received from the vending machine via infrared signals.

4. The communication device of claim 1 wherein the transmitter is configured to transmit at least a portion of the information received from the vending machine via radio frequency signals.

5. The communication device of claim 1, further comprising a receiver configured to receive wireless signals from the data collection device.

6. The communication device of claim 1, further comprising a PIN photodiode configured to receive wireless signals from the data collection device.

7. The communication device of claim 1, further comprising a receiver configured to receive wireless signals from the data collection device and transmit the signals to a vending machine controller positioned within the vending machine.

8. The communication device of claim 1 wherein the controller is configured to receive information from the vending machine related to sales made by the vending machine.

9. The communication device of claim 1 wherein the controller is configured to receive information from the vending machine related to maintenance of the vending machine.

10. The communication device of claim 1 wherein the controller is configured to receive vend data from the vending machine, wherein the transmitter includes an infrared emitter diode configured to transmit at least a portion of the vend data to the data collection device via infrared signals, and wherein the communication device further includes a PIN photodiode configured to receive wireless signals from the data collection device.

11. The communication device of claim 1 wherein the controller includes an imbedded application that causes the controller to forward vend data from the vending machine to the transmitter for wireless transmission to the data collection device.

12. The communication device of claim 1 wherein the controller includes an imbedded application that causes the controller to forward vend data and a machine identification number from the vending machine to the transmitter for wireless transmission to the data collection device.

13. A data transceiver for use with a vending machine, the data transceiver comprising:
a body configured to be attached to a portion of the vending machine;
a microcontroller supported by the body, wherein the microcontroller is configured to receive vend data from the vending machine; and
an optical transceiver module operably connected to the microcontroller, wherein the optical transceiver module includes an infrared transmitter and an infrared receiver, wherein the infrared receiver is configured to receive instructions from a data collection device spaced apart from the data transceiver, and wherein the infrared transmitter is configured to transmit at least a portion of the vend data to the data collection device in response to the instructions.

14. The data transceiver of claim 13, further comprising a communication controller operably interposed between the optical transceiver module and the microcontroller, wherein the communication controller is configured to encode data sent by the microcontroller to the optical transceiver module, and wherein the communication controller is further configured to decode data sent by the optical transceiver module to the microcontroller.

15. A vending machine comprising:
a monetary input device configured to receive a monetary instrument from a user; and
a transmitter configured to receive information from the monetary input device, wherein the transmitter is further configured to wirelessly transmit the information to a data collection device spaced apart from the transmitter.

16. The vending machine of claim 15, further comprising a metering component operably connected to the monetary input device and the transmitter, wherein the metering component is configured to compile vend data based on information received from the monetary input device, and wherein the transmitter is configured to wirelessly transmit the vend data to the data collection device.

17. The vending machine of claim 15 wherein the monetary input device includes a coin acceptor configured to receive one or more denomination of coin from a user.

18. The vending machine of claim 15 wherein the monetary input device includes a card reader configured to read one or more types of payment card provided by a user.

19. The vending machine of claim 15 wherein the transmitter is configured to wirelessly transmit the information to the data collection device via infrared signals.

20. The vending machine of claim 15, further comprising;
a merchandize-holding portion;
a plurality of prizes positioned in the merchandize-holding portion; and
a movable grasping device positioned in the merchandize-holding portion proximate to the prizes, wherein the grasping device is responsive to user input and able to selectively grasp and move at least one of the prizes upon receipt of a preselected amount of monetary value via the monetary input device.

21. A system comprising:
a vending machine, the vending machine including:
a monetary input device configured to receive a monetary instrument from a user; and
a transmitter configured to receive vend information from the monetary input device; and
a data collection device spaced apart from the vending machine, wherein the data collection device is configured to wirelessly receive the vend information from the transmitter.

22. The system of claim 21 wherein the data collection device includes an infrared signal port configured to receive the vend information from the transmitter.

23. A computer-readable medium containing computer-executable instructions configured to cause a data transceiver associated with a vending machine to transmit information by a method comprising:
receiving a request for vend data; and
in response to receiving the request, wirelessly transmitting the vend data to a data collection device spaced apart from the vending machine.

24. The computer-readable medium of claim 23, further comprising:
receiving a request for test data; and
in response to receiving the request for test data, wirelessly transmitting the test data to the data collection device.

25. The computer-readable medium of claim 23 wherein receiving a request for vend data includes receiving a password from a hand-held computing device, and wherein wirelessly transmitting the vend data to a data collection device includes wirelessly transmitting the vend data to the hand-held computing device.

26. The computer-readable medium of claim 23, further comprising in response to receiving the request, wirelessly transmitting a machine identification number to the data collection device.

27. A method for use with a vending machine, the method comprising:
receiving a first monetary input from a first user;
receiving a second monetary input from a second user; and
wirelessly transmitting information related to the first and second monetary inputs from the vending machine to a remote device spaced apart from the vending machine.

28. The method of claim 27 wherein wirelessly transmitting information related to the first and second monetary inputs from the vending machine to a remote device includes wirelessly transmitting the information to a remote central computer.

29. The method of claim 27 wherein wirelessly transmitting information related to the first and second monetary inputs from the vending machine to a remote device includes wirelessly transmitting the information to a hand-held computing device.

30. The method of claim 27, further comprising counting the first and second monetary inputs to determine a value, wherein wirelessly transmitting information includes wirelessly transmitting the value from the vending machine to the remote device.

31. The method of claim 27, further comprising determining a number of times the vending machine was used based on the first and second monetary inputs, wherein wirelessly transmitting information includes wirelessly transmitting the number from the vending machine to the remote device.

32. The method of claim 27, further comprising wirelessly transmitting an identification number of the vending machine to the remote device.

33. The method of claim 27 wherein wirelessly transmitting information includes wirelessly transmitting information via infrared signals.

34. The method of claim 27, further comprising wirelessly receiving a signal from the remote device, wherein wirelessly transmitting information includes wirelessly transmitting information in response to receiving the signal from the remote device.

35. The method of claim 27, further comprising:
wirelessly receiving a password from the remote device; and
verifying the password, wherein wirelessly transmitting information includes wirelessly transmitting information in response to verifying the password.

36. A method for servicing a vending machine, the method comprising:
collecting money from within the vending machine;
wirelessly collecting vend data from the vending machine, wherein the vend data is associated with the collected money; and
transferring the vend data to a remote computing system.

37. The method of claim 36, further comprising:
wirelessly collecting test data from the vending machine, wherein the test data is associated with test uses of the vending machine; and
transferring the test data from the vending machine to the remote computing system.

38. A system for use with a vending machine, the system comprising:
means for receiving a first monetary input from a first user;
means for receiving a second monetary input from a second user; and
means for wirelessly transmitting information related to the first and second monetary inputs from the vending machine to a data collection device spaced apart from the vending machine.

39. The system of claim 38, further comprising means for rendering the vending machine at least partially inoperable in response to tampering with the means for wirelessly transmitting information.

40. The system of claim 38, further comprising:
means for performing a test of the vending machine; and
means for wirelessly transmitting information related to the test to the data collection device.
